(19) United States
(12) Patent Application Publication
(10) Pub. No.: US 2014/0219491 A1
(43) Pub. Date: Aug. 7, 2014

(54) PILLAR SPEAKER

(71) Applicant: Stelle LLC, Newport Beach, CA (US)

(72) Inventors: Wayne Ludlum, Fountain Valley, CA (US); David Cox, San Clemente, CA (US); QH Liu, Guangzhou (CN)

(73) Assignee: Stelle LLC, Newport Beach, CA (US)

(21) Appl. No.: 13/843,822

(22) Filed: Mar. 15, 2013

Related U.S. Application Data
(60) Provisional application No. 61/761,661, filed on Feb. 6, 2013.

(51) Int. Cl. H04R 1/02

(52) U.S. Cl. CPC H04R 1/02
USPC 381/387

(57) ABSTRACT

A loudspeaker system including a top firing, 360 degree, time aligned, powered loudspeaker system that comprises a cylindrical body, having a top end and a bottom end, and an upper interior compartment and a lower interior compartment; a first speaker driver and a second speaker driver, each being positioned within the upper interior compartment, and each being oriented to face towards the top end of the cylindrical body; at least one subwoofer having an upper end and a lower end, the at least one subwoofer being positioned within the lower interior compartment and oriented to face towards the bottom end of the cylindrical body; and a narrow band of multiple openings on the cylindrical body, proximate the bottom end of the cylindrical body, and adjacent to the lower end of the at least one subwoofer, the narrow band of multiple openings spanning 360 degrees around the cylindrical body. The first and second speaker drivers are outwardly angled from the vertical.

### CROSS REFERENCE TO RELATED APPLICATIONS

This application claims the benefit of U.S. Provisional Patent Application No. 61/761,661, filed on Feb. 6, 2013, the entirety of which is incorporated herein by reference.

### FIELD OF THE INVENTION

The present invention relates to an improved cylindrical, self-contained, 360 degree, full-range loudspeaker system.

### BACKGROUND OF THE INVENTION

In the field of sound reproduction, it is desirable to have loudspeaker system that exists as a stand alone or single device or unit, such that it can be readily set up, moved, or transported, and where the design and placement of the speakers is optimized to attain high quality sound reproduction.

### SUMMARY OF THE PREFERRED EMBODIMENTS

In accordance with the present invention, a loudspeaker system is provided that includes a top firing, 360 degree, time aligned, powered loudspeaker system, which comprises a cylindrical body, having a top end and a bottom end, and an upper interior compartment and a lower interior compartment; a first speaker driver and a second speaker driver, each being positioned within the upper interior compartment, and each being oriented to face towards the top end of the cylindrical body; at least one subwoofer having an upper end and a lower end, the at least one subwoofer being positioned within the lower interior compartment and oriented to face towards the bottom end of the cylindrical body; and a narrow band of multiple openings on the cylindrical body, proximate the bottom end of the cylindrical body, and adjacent to the lower end of the at least one subwoofer, the narrow band of multiple openings spanning 360 degrees around the cylindrical body. The first and second speaker drivers are outwardly angled from the vertical. In a preferred embodiment, the lower interior compartment has a volume that is greater than the volume of the upper interior compartment. Preferably, the first and second speaker drivers are angled outwardly in the range of about 10 to 45 degrees from the vertical. Preferably, a top cover is fitted to the top end of the cylindrical body, the top cover having a first area of multiple holes and a second area of multiple holes. Preferably, the top cover is fitted to the top end of the cylindrical body such that the first area of multiple holes generally is aligned above the first speaker driver, and the second area of multiple holes generally is aligned above the second speaker driver. Preferably, the first and second speaker drivers are angled outwardly in the range of about 20 to 35 degrees from the vertical. Preferably, the first and second speaker drivers are angled outwardly at about 25 degrees from the vertical.

In accordance with another aspect of the present invention, a top firing, 360 degree, time aligned, powered loudspeaker system is provided, which comprises a cylindrical body, having a top end and a bottom end; a first speaker driver and a second speaker driver, each being positioned proximate the top end of the cylindrical body and contained within a first compartment of the cylindrical body; and at least one subwoofer having an upper end and a lower end, the at least one subwoofer being positioned proximate the bottom end of the cylindrical body and contained within a second compartment of the cylindrical body. The first and second speaker drivers are outwardly angled from the vertical. In a preferred embodiment, the system comprises a narrow band of multiple openings on the cylindrical body, proximate the bottom end of the cylindrical body, and adjacent to the lower end of the at least one subwoofer. Preferably, the narrow band of multiple openings spans 360 degrees around the cylindrical body. Preferably, the first and second speaker drivers are angled outwardly in the range of about 10 to 45 degrees from the vertical. Preferably, a top cover is fitted to the top end of the cylindrical body, the top cover having a first area of multiple holes and a second area of multiple holes. Preferably, the top cover is fitted to the top end of the cylindrical body such that the first area of multiple holes generally is aligned above the first speaker driver, and the sccond area of multiple holes generally is aligned above the second speaker driver. Preferably, the first and second speaker drivers are angled outwardly in the range of about 20 to 35 degrees from the vertical. Preferably, the first and second speaker drivers are angled outwardly at about 25 degrees from the vertical.

### BRIEF DESCRIPTION OF THE DRAWINGS

FIG. 1 is a side elevation view of the interior of a cylindrical speaker system in accordance with a preferred embodiment of the present invention;

FIG. 2 is a front perspective view of the exterior of the cylindrical speaker system of FIG. 1;

FIG. 3 is a side elevation view of the exterior of the cylindrical speaker system of FIG. 1;

FIG. 4 is a side elevation view of the exterior of the cylindrical speaker system of FIG. 1;

FIG. 5 is amide elevation view of the exterior of the cylindrical speaker system of FIG. 1;

FIG. 6 is a side elevation view of the exterior of the cylindrical speaker system of FIG. 1;

FIG. 7 is a top plan view of the exterior of the cylindrical speaker system of FIG. 1; and

FIG. 8 is a bottom plan view of the exterior of the cylindrical speaker system of FIG. 1.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but are not necessarily, references to the same embodiment; and, such references are intended to refer to at least one of the embodiments.

Reference in this specification to “one embodiment” or “an embodiment” means that a particular feature, structure, or characteristic described in connection with the embodiment is included in at least one embodiment of the-disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments. Unless otherwise stated, like numerals within the figures refer to the same or similar features or aspects of the present invention, as among all figures.

The terms used in this specification generally are intended to have their ordinary meanings in the art, within the context of the disclosure, and in the specific context where each term is used. Certain terms that are used to describe the disclosure are discussed below, or elsewhere in the specification, to provide additional guidance to one of skill in the art regarding the description of the disclosure. For convenience, certain terms may be highlighted, for example using italics and/or quotation marks. The use of any such highlighting has no influence on the scope and meaning of a term; the scope and meaning of a term is the same, in the same context, whether or not it is highlighted.

It will be appreciated that the same thing can be said in morc than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

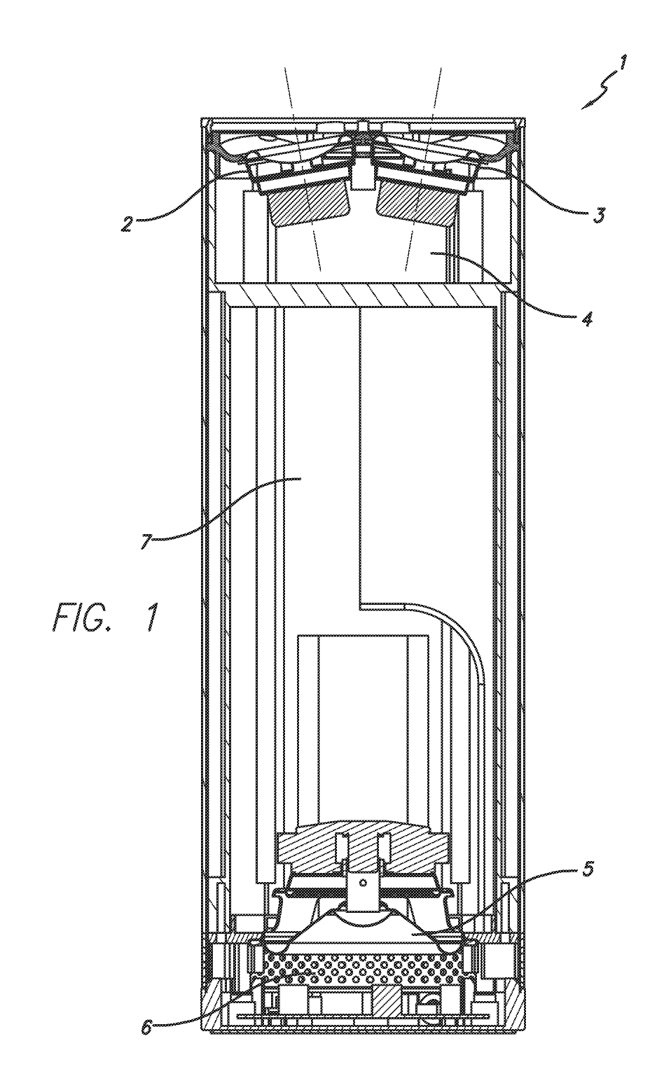

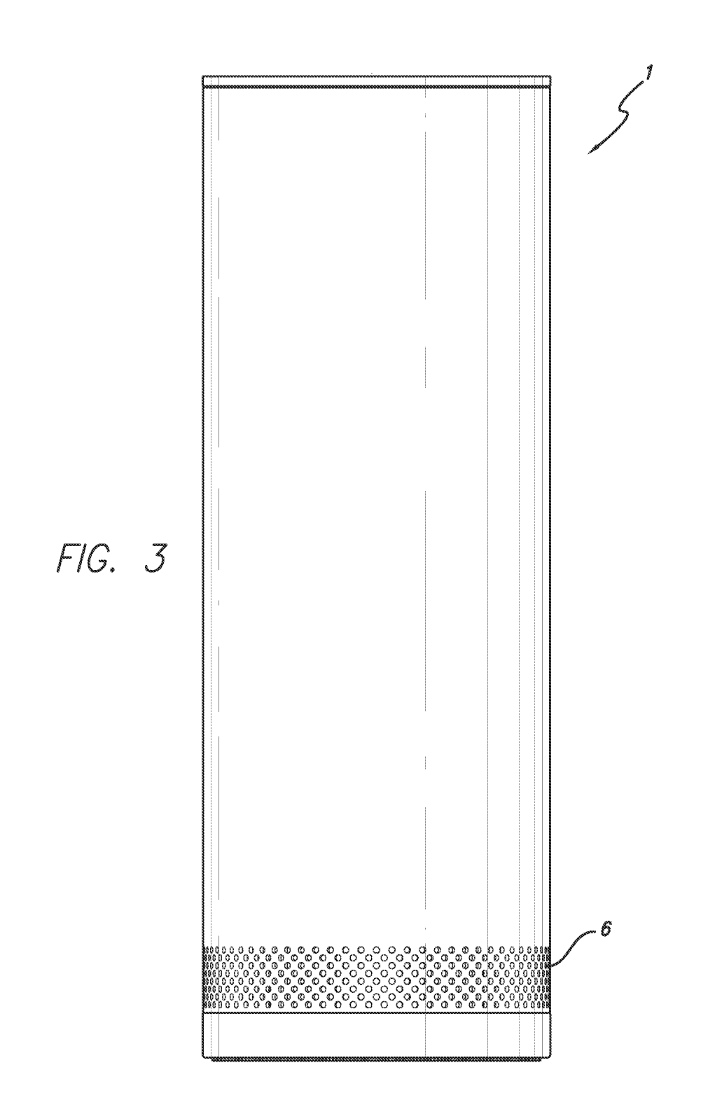

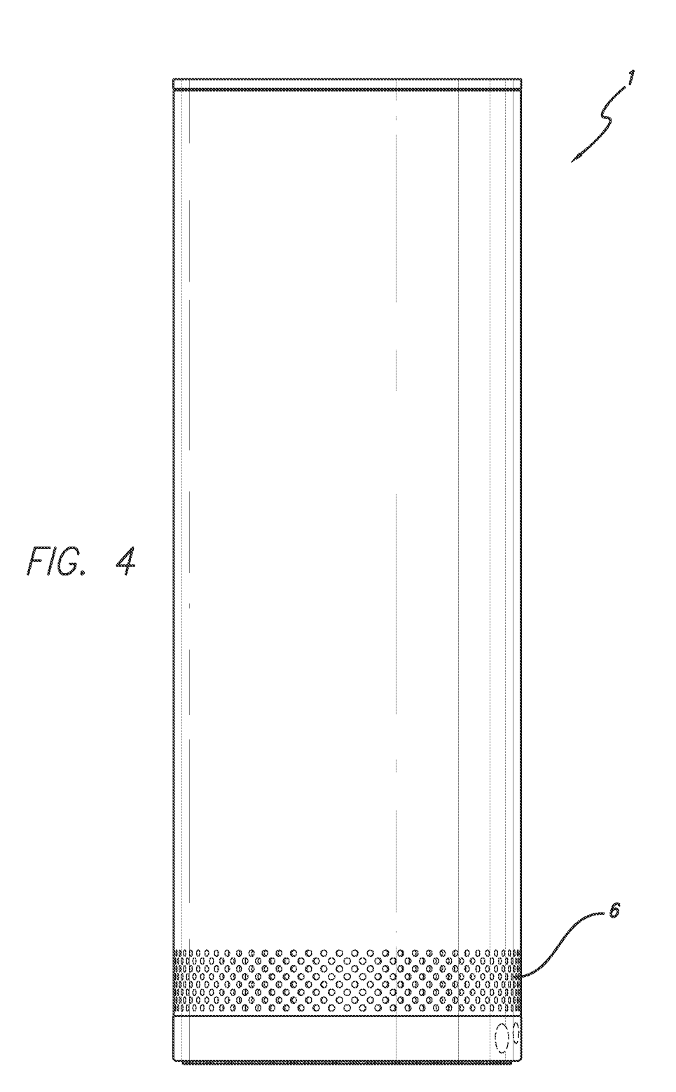

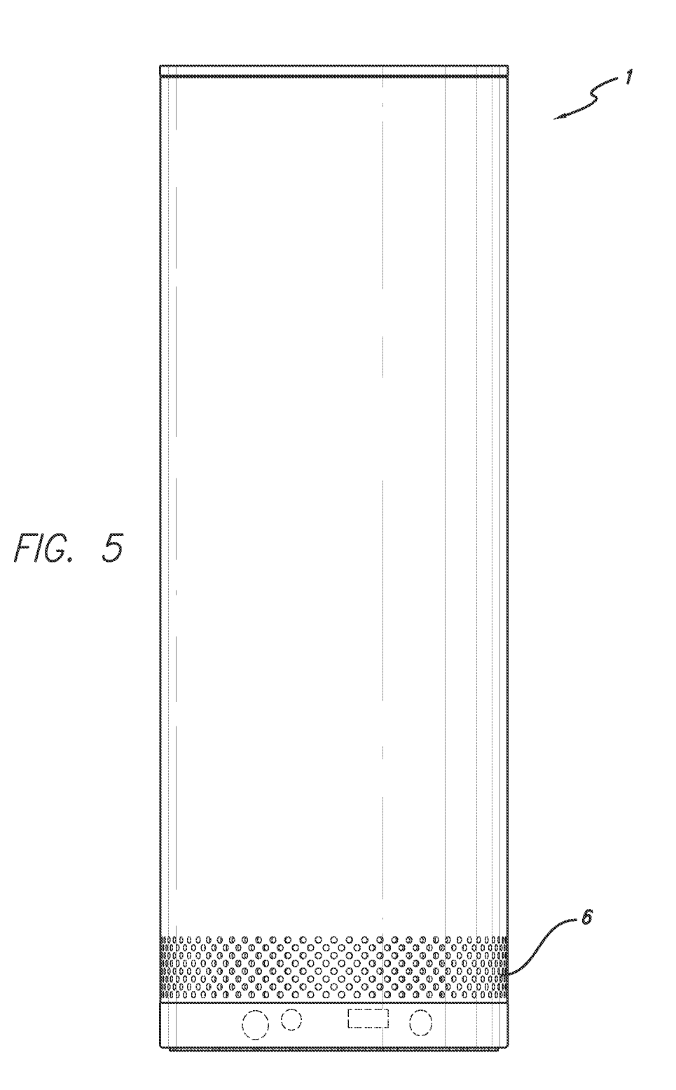

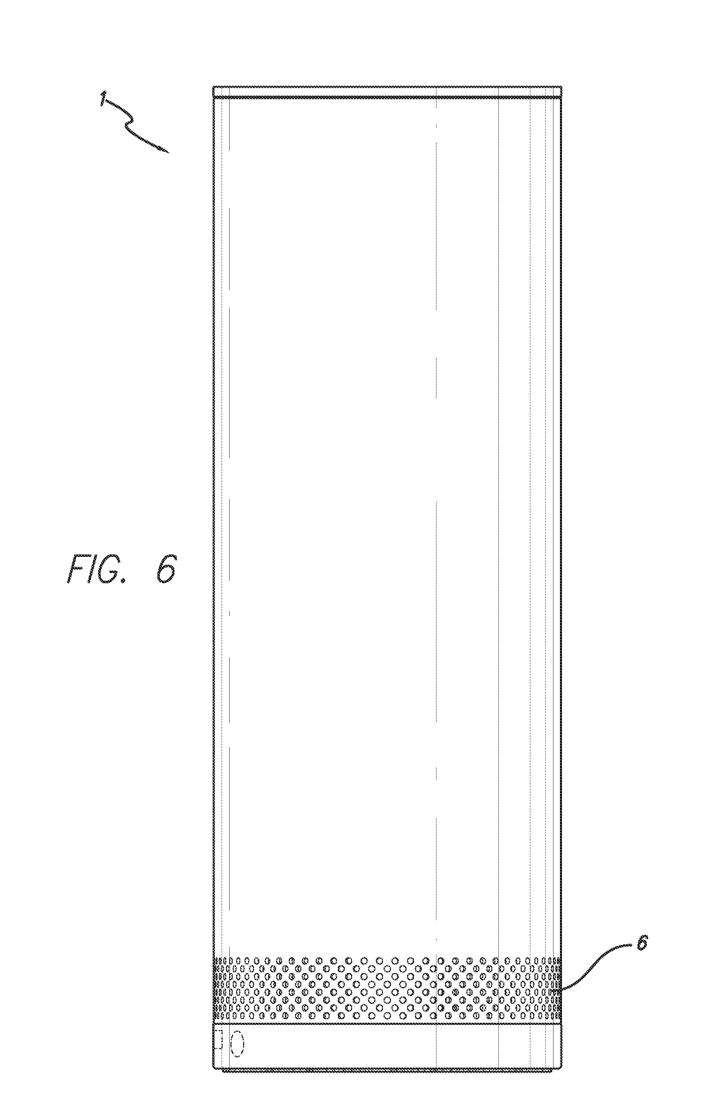

Disclosed herein is a top firing, 360 degree, time aligned, powered loudspeaker system 1, comprising at least two top firing, angled drivers 2 and 3, and at least one down firing subwoofer 5, as shown in FIGS. 1 through 8. The loudspeaker system 1 is a “2.1” system because the angled drivers 2 and 3 reproduce the left and right sound channels at higher frequencies, and down firing subwoofer 5 reproduces a combination of the left and right sound channels, at lower frequencies.

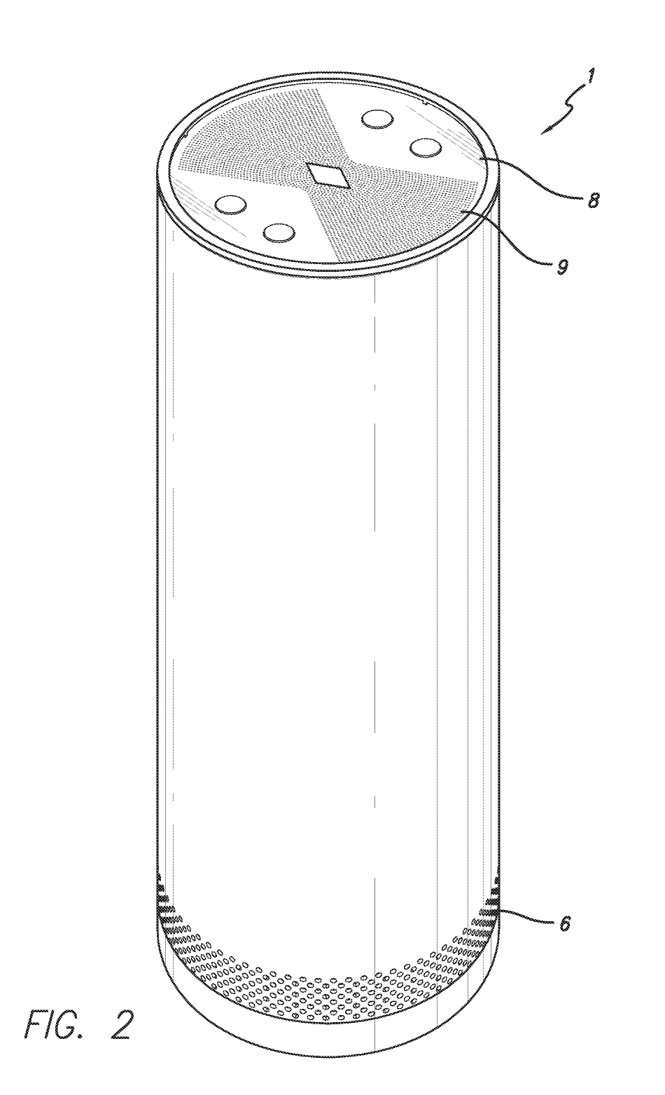

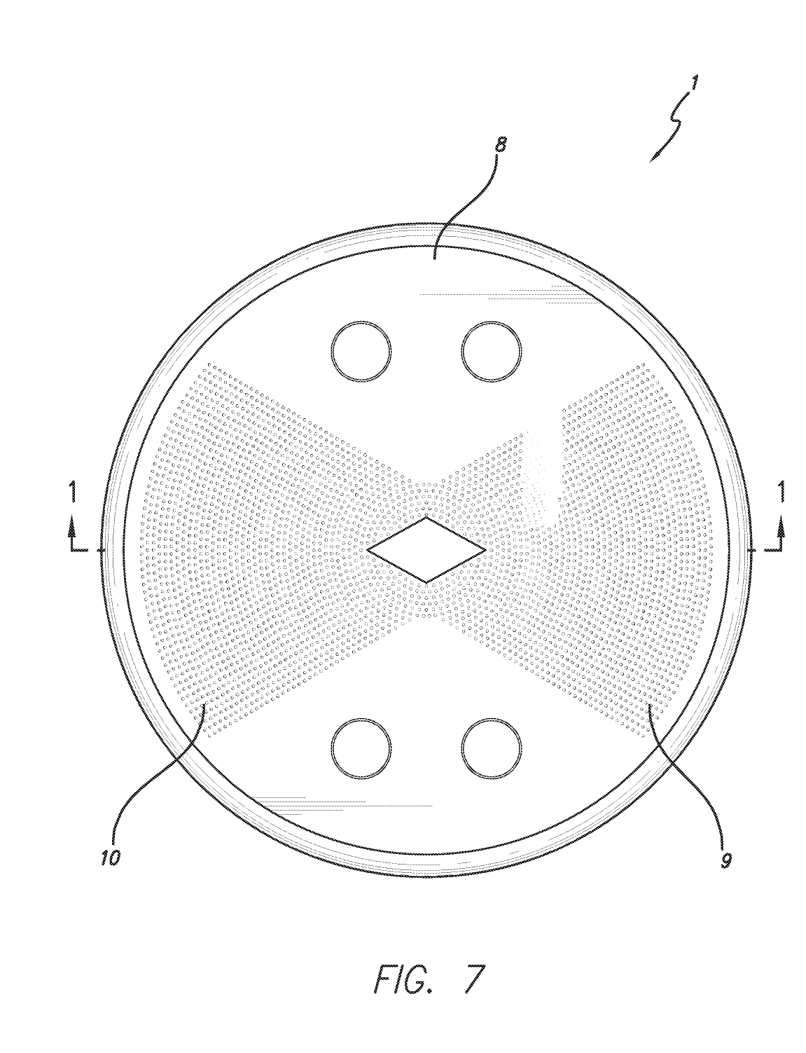

Angled drivers 2 and 3, and their firing axis/angle relative to vertical, are shown in FIG. 1. Top firing drivers 2 and 3 reproduce sound at 360 degrees as a result of a tuned waveguide for proper dispersion. The sound pressure radiated from the angled drivers 2 and 3 is angled and dispersed in such a way so as to transmit wide beam transmission at angles away from one another. As the sound pressure travels farther away from the loudspeaker cones of angled drivers 2 and 3, the dispersion is widened resulting in both near field and long field pattern control, and resulting in sound being dispersed at 360 degrees. Ideally, the angled drivers 2 and 3 are set at an outwardly facing angle, somewhere in the range of about 10 degrees to about 45 degrees from vertical, preferably in the range of about 20 to about 35 degrees, or more preferably at about 25 degrees. Angled drivers 2 and 3 are placed within acoustic chamber 4, as can be seen in FIG. 1, and top cover 8 is fitted on top of angled drivers 2 and 3, as can be seen in FIGS. 2 and 7. Top cover 8 has an area of multiple small holes 9 and another area of multiple small holes 10, and the top cover 8 is oriented such that the area multiple small holes 9 is generally or directly above either of the angled drivers 2 or 3, and the area of multiple small holes 10 is generally or directly above the other of angled drivers 2 or 3.

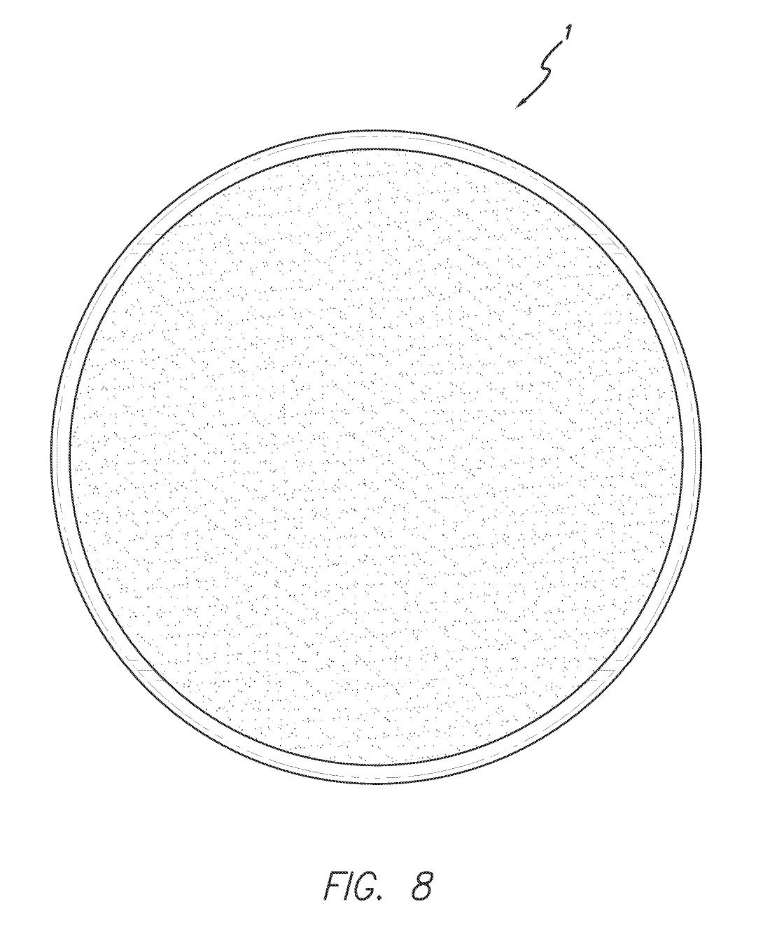

Down firing subwoofer 5 is shown in FIG. 1. The down firing subwoofer 5 is positioned in an acoustic chamber 7 that allows for sound pressure to build as it is produced and compressed out a 360 degree side grille 6, which is comprised of a narrow band of multiple small openings positioned immediately adjacent to the cone of down firing subwoofer 5, as can be seen in FIGS. 1 through 6. The bottom of the loudspeaker system 1 is closed or sealed (as can be seen in FIG. 8), and, other than the multiple small openings of side grille 6, the acoustic chamber 7 into which down firing subwoofer 5 is placed is entirely closed or sealed, as can be seen in FIGS. 1 through 6. Accordingly, sound pressure built into the tube “time align” with high frequency output fired out of the top speakers due to the energy compressed in acoustic chamber 7. The multiple small openings of side grille 6 can comprise any density, but preferably in the range of 5 to 25 openings per square inch, the openings being sized such that the openings occupy somewhere in the range of 25 to 65 percent of the surface area of side grille 6.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize Further, any specific numbers noted herein are only examples: alternative implementations may employ differing values, measurements or ranges.

The teachings of the disclosure provided herein can be applied to other systems, not necessarily the system described above. The elements and acts of the various embodiments described above can be combined to provide further embodiments. Any measurements described or used herein are merely exemplary and not a limitation on the present.

While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

Although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A top firing, 360 degree, time aligned, powered loudspeaker system, comprising:
a cylindrical body, having a top end and a bottom end, and an upper interior compartment and a lower interior compartment;
a first speaker driver and a second speaker driver, each being positioned within the upper interior compartment, and each being oriented to face towards the top end of the cylindrical body;
at least one subwoofer having an upper end and a lower end, the at least one subwoofer being positioned within the lower interior compartment and oriented to face towards the bottom end of the cylindrical body;
a narrow band of multiple openings on the cylindrical body, proximate the bottom end of the cylindrical body, and adjacent to the lower end of the at least one subwoofer, the narrow band of multiple openings spanning 360 degrees around the cylindrical body;
wherein the first and second speaker drivers are outwardly angled from the vertical.

2. The powered loudspeaker system of claim 1, wherein the lower interior compartment has a volume that is greater than the volume of the upper interior compartment.

3. The powered loudspeaker system of claim 2, wherein the first and second speaker drivers are angled outwardly in the range of about 10 to 45 degrees from the vertical.

4. The powered loudspeaker system of claim 3, wherein a top cover is fitted to the top end of the cylindrical body, the top cover having a first area of multiple holes and a second area of multiple holes.

5. The powered loudspeaker system of claim 4, wherein the top cover is fitted to the top end of the cylindrical body such that the first area of multiple holes generally is aligned above the first speaker driver, and the second area of multiple holes generally is aligned above the second speaker driver.

6. The powered loudspeaker system of claim 5, wherein the first and sccond speaker drivers are angled outwardly in the range of about 20 to 35 degrees from the vertical.

7. The powered loudspeaker system of claim 5, wherein the first and second speaker drivers are angled outwardly at about 25 degrees from the vertical.

8. A top firing, 360 degree, time aligned, powered loudspeaker system, comprising:
a cylindrical body, having a top end and a bottom end;
a first speaker driver and a second speaker driver, each being positioned proximate the top end of the cylindrical body and contained within a first compartment of the cylindrical body;
at least one subwoofer having an upper end and a lower end, the at least one subwoofer being positioned proximate the bottom end of the cylindrical body and contained within a second compartment of the cylindrical body;
wherein the first and second speaker drivers are outwardly angled from the vertical.

9. The powered loudspeaker system of claim 8 further comprising a narrow band of multiple openings on the cylindrical body, proximate the bottom end of the cylindrical body, and adjacent to the lower end of the at least one subwoofer.

10. The powered loudspeaker system of claim 9, wherein the narrow band of multiple openings spans 360 degrees around the cylindrical body.

11. The powered loudspeaker system of claim 10, wherein the first and second speaker drivers are angled outwardly in the range of about 10 to 45 degrees from the vertical.

12. The powered loudspeaker system of claim 11, wherein a top cover is fitted to the top end of the cylindrical body, the top cover having a first area of multiple holes and a second area of multiple holes.

13. The powered loudspeaker system of claim 12, wherein the top cover is fitted to the top end of the cylindrical body such that the first area of multiple holes generally is aligned above the first speaker driver, and the second area of multiple holes generally is aligned above the second speaker driver.

14. The powered loudspeaker system of claim 13, wherein the first and second speaker drivers are angled outwardly in the range of about 20 to 35 degrees from the vertical.

15. The powered loudspeaker system of claim 13, wherein the first and second speaker drivers are angled outwardly at about 25 degrees from the vertical.
